(19) United States
(12) Patent Application Publication
(10) Pub. No.: US 2007/0293318 A1
(43) Pub. Date: Dec. 20, 2007

(54) VIDEO GAME CONTROLLER

(75) Inventors: Kenneth TETTERINGTON, Edmonton (CA); Nan LIU, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: SPLITFISH GAMEWARE INC., Edmonton (CA)

(21) Appl. No.: 11/691,241

(22) Filed: Mar. 26, 2007

Related U.S. Application Data
(60) Provisional application No. 60/743,791, filed on Mar. 27, 2006.

(51) Int. Cl. A63F 13/06

(52) U.S. Cl. 463/37

(57) ABSTRACT

A video game controller includes separate left hand and right hand controller shells. The left hand controller has a conventional joystick movement controller, while the right hand controller has a trackball movement controller. One or both of the left hand and right hand controllers include a sensitivity module which augments or diminishes the movement signal sent by the controller in response to player input.

### CROSS REFERENCE TO RELATED APPLICATIONS

This application claims the priority benefit of U.S. Provisional Patent Application 60/743,791 filed on Mar. 27, 2006 entitled “Video Game Controller”, the contents of which are incorporated herein by reference.

### FIELD OF THE INVENTION

The present invention relates to a method and apparatus that allows interaction between a game player and a video game console system with a controller.

### BACKGROUND

The recent expansion in the number of users of video game consoles combined with the use of larger, more complex video games has caused video game players to play for extended time periods on a video game console. Current video game controllers for the Sony Playstation™ 2 and xBox™, and xBox 360^{TH} video game console systems have two smaller joysticks on the top of the controller that are programmed to allow a game player's game character to move left, right, up or down with the right joystick and a second left joystick that allows a player to move forward, backward, to the left or to the right.

Both the left and right controller joysticks are moved by the player's thumbs by moving the sticks forward, backward, left or right. These stick movements are extensive in video games as the main means by which a game player can move their video game character. Due to the size and complexity of the video games in present video game consoles, extended periods of use with the current video game console controllers can cause calluses and sores on the video game players thumbs, as well as injuries associated with repetitive strain.

To date, the Sony Playstation™ has been in existence since the Sony Playstation™ 1 and has evolved to the Sony Playstation™ 2 and Playstation™ 3. The Microsoft xBox™ has been in existence since the first generation xBox™ and more recently this has been replaced with the xBox 360™.

All leading video game consoles have limitations with respect of their controllers as they use a similar style of left and right controllers, or a combination of joysticks on the controllers. Current video game controllers use a single shell to contain all the buttons that are controlled by both left and right hand fingers.

Furthermore, current video game controllers have electronics that detect movements of the left and right controller sticks. As such, all known controllers are fixed in respect to the level of movement that the controller sticks allow. In a sense, these sticks are hardwired to an average game, however not all video games use the same standard for their own programming of processing these left or right stick movements. This effect can cause certain video games to respond far too little or far too much and make it difficult for the video game player to maneuver with accuracy for all video games.

There is a need in the art for a novel game controller which mitigates the difficulties of the prior art.

### SUMMARY OF THE INVENTION

The present invention relates to a video game controller and, in particular, to such a controller which provides an alternative to the joystick controllers of the prior art, which may have more tactile feedback than a regular controller, and allows the video game player to adjust the response of the controller while playing a video game.

Therefore, in one aspect, the invention may comprise a video or computer game controller comprising: P1 (a) separate left hand and right hand controller shells each having a game player movement control means, each operatively connected to a game console or game processor;
(b) wherein one of the left hand or right hand controller movement control means comprises a trackball; and
(c) wherein one or both of the left and right hand controller comprises a sensitivity module for augmenting or diminishing a movement signal outputted by the controller.

In one embodiment the sensitivity module has at least 3 modes comprising an augmentation mode, a neutral mode, and a diminution mode. In another embodiment both the left hand and right hand controllers comprise a sensitivity module. In one embodiment the sensitivity module is controlled by a slider switch or a thumbwheel.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a schematic representation of one embodiment of the present invention.

FIG. 2 shows the trackball mechanism of one embodiment of the controller of the present invention.

### DETAILED DESCRIPTION OF PREFERRED EMBODIMENTS

The present invention provides for an interactive game controller. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

The game controller (10) of the present invention alleviates difficulties a video game player may encounter as a result of using the thumb-actuated joysticks of conventional game controllers. Furthermore, it also allows the video game player to adjust the sensitivity on the invention to fit the precision of movement required of the specific video game being played.

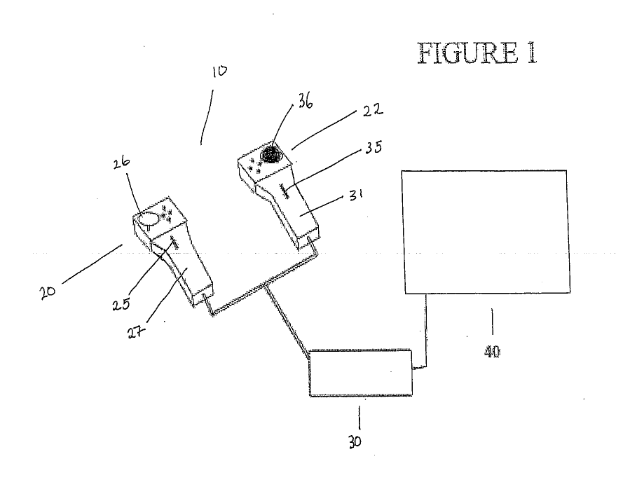

As seen in FIG. 1, the controller (10) is used with a video game console system (30) that is commercially available from third parties. These video game console systems (30) are readily available with current brand names such as Sony's Playstation™, Microsoft's XBox™ and Nintendo's Game Cube™. It should be apparent that the invention herein described can be adapted to either older, current or future game console systems (30) as well as computer controller systems, without detracting from spirit or the scope of the described invention. The game console (30) is connected to a conventional television (40) or video monitor as is well-known in the art.

The controller (10) of the present invention splits the control mechanism into a left hand grip shell (20) and a separate right hand grip shell (22) which are both connected to the video game console system (30) by way of wires. Alternatively, it should be apparent that the controller (10) herein maybe connected to the video game console system (30) via wireless means such as radio frequency or infrared wireless transmission techniques.

Preferably, the left and right shells (20, 22) are ergonomically shaped to fit into the respective hands of the user. In one embodiment, one of the left shell (20) and the right shell (22) has a conventional joystick, and the other has a trackball in the place of the joystick. Preferably, with most game systems, and for right-handed users, it is the right shell (22) that includes the trackball.

In one embodiment, one or both of the left shell (20) and right shell (22) have an adjustable switch for adjusting the sensitivity of controller. In one embodiment, the left shell slider switch (25) adjusts a sensitivity module (27) which intercepts the bi-directional signal outputted from the left shell joystick (26). The left shell slider switch (25) has an electronic chip or circuitry that can adjust the sensitivity of the controller by augmenting or diminishing the movement signal included in the data packet transmitted by the controller. Preferably, the augmentation or diminution of the signal is proportionate. The right shell slider switch (35) is connected to a sensitivity module (31) for the right shell (22) electronic circuit of the right shell trackball (36).

In one embodiment, both the left shell slider switch (25) and the right shell slider switch (35) have at least three adjustments: one which augments the movement, a neutral setting, and one that decreases or diminishes the movement. In a preferred embodiment, the switches may have five different adjustments, which add offsets in the amounts of −2, −1, 0, +1, and +2 to the SPI protocol that is sent to the video game console (30). The video game software processes the offsets as if the video game player pressed the left shell stick (26) or right shell track ball (36) less or more depending on the offsets chosen by the video game player. It should be apparent to one skilled in the art that alternative electrical components can be used to adjust the offsets. For example, adjustment may be performed by a thumbwheel, instead of a slider switch.

In one embodiment, the right shell has a trackball (36) instead of right shell stick as other controllers use. The right shell trackball (36) is made out of solid plastic, however one skilled in the art will realize that many other materials can be used for the right shell trackball (36). Roller balls such as a roller mouse or a trackball for use with personal computers are well-known. Conventionally, a ball is housed in a ball cage, and optically or frictionally engages encoders which translate movement of the ball into electronic control signals. Such mechanisms are well-known in the art and need not be further described herein.

The preferred size of the right shell trackball (36) is ⅝ of an inch in radius, however, size is not an essential element of the invention. The video game player uses his or her right thumb to move the right shell trackball (36). The right shell trackball (36) is much easier to move and has less friction than a typical controller stick. The right shell trackball (36) is much closer to the surface of the right shell and therefore is more comfortable to use and requires less movement of the video game player's thumb to move.

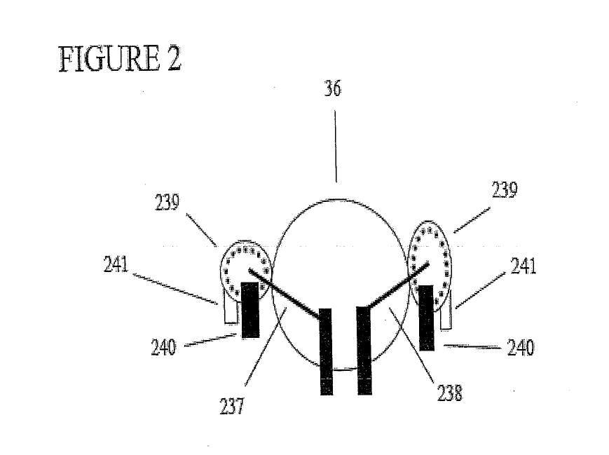

As shown in FIG. 2, in one embodiment, the right shell trackball (36) sits on 2 barrel pin rollers. The barrel pin rollers are allowed to rotate freely. One barrel pin roller (237) rotates and controls the video game player's “X” look at position while the other barrel pin roller (238) rotates and controls the video game player's “Y” look at position, in a conventional X-Y coordinate grid.

In one embodiment, the present invention employs a slotted wheel (239) that is attached to each barrel pin roller (237, 238). In combination, each barrel pin roller has a photodiode (240) that emits light on one side of the slotted wheel and a corresponding light detector (241) that detects light emitted from the companion light emitter. The combination of the slotted wheel (239), light emitter (240) and light detector (241) has electronic circuitry that counts the on and off pulses when the slotted wheel (239) is blocking or allowing light to connect between the light emitter (240) and light detector (241). The count is processed then sent to the video game console (30) where the video game processes the count as a movement.

The invention can either use a round casing or an third barrel pin roller on the adjacent side to allow the right shell track ball (36) to rotate freely. It should be apparent that other means can be used to allow the right shell trackball (36) to rotate freely such as adjoining ball bearings.

The controller of the present invention may utilize standard buttons that are mounted on electronic circuits for all other video game functions. These combinations of buttons and electronics that process the bi-directional protocols are well known to those skilled in the art and do not form part of the invention claimed herein.

What is claimed is:

1. A video or computer game controller comprising:
(a) separate left hand and right hand controller shells wherein at least one of the left hand controller or right hand controller comprises a game player movement control means, and each is operatively connected to a game console or game processor;
(b) wherein the game player movement control means comprises a trackball; and
(c) wherein one or both of the left and right hand controller comprises a sensitivity module for augmenting or diminishing a movement signal outputted by the controller.

2. The controller of claim 1 wherein the sensitivity module has at least 3 modes comprising an augmentation mode, a neutral mode, and a diminution mode.

3. The controller of claim 1 wherein both the left hand and right hand controllers comprise a sensitivity module.

4. The controller of claim 1 wherein the sensitivity module is controlled by a slider switch or a thumbwheel.

5. The controller of claim 1 wherein both the left hand and right hand controllers each comprises game player movement control means, and at least one of the left hand or right hand controller game player movement control means comprises a trackball.
